(19) United States
(12) Patent Application Publication
(10) Pub. No.: US 2005/0053703 A1
(43) Pub. Date: Mar. 10, 2005

(54) Sanitizing food products with prewash

(76) Inventors: Liangji Xu, Naperville, IL (US); Richard Gaber, Clarendon Hills, IL (US); Terry Traeder, Aurora, IL (US)

Correspondence Address: PRAXAIR, INC.;LAW DEPARTMENT - M1 557, 39 OLD RIDGEBURY ROAD, DANBURY, CT, 06810-5113, US

(21) Appl. No.: 10/654,934

(22) Filed: Sep. 5, 2003

(51) Int. Cl. A23K 1/00

(52) U.S. Cl. 426/335

(57) ABSTRACT

A food product having on its surface at least one substance that reacts with a sanitizing compound to be applied to the food product is sanitized by applying an aqueous prewashing liquid to remove at least a portion of said substance and then applying an aqueous sanitizing liquid that contains ozone, each liquid being sprayed onto all exterior surfaces of the food product from a plurality of directions while moving the food product laterally with respect to the sprays, maintaining contact between said sanitizing liquid and said food product for at least a time effective to maximize wetting of the surface of the food product by the sanitizing liquid, and then removing mechanically at least 75% of the sanitizing liquid from said food product.

### FIELD OF THE INVENTION

This invention relates to sanitizing food products, which preserves their appearance and extends their shelf life.

### BACKGROUND OF THE INVENTION

As one technique for sanitizing a food product, it is desirable to eliminate microbial contamination from the surface of the food product before the food product is presented to the consumer for consumption. Conventionally, food products have been sanitized by immersing the food product in a water bath or in a flowing stream of water containing a sanitizing agent, following which the food product is centrifuged to remove water. This is a relatively unsatisfactory technique because the product retains so much water that retaining the physical properties, freshness and attractive appearance of the original product becomes difficult.

It has also been proposed in the past to employ ozone, or aqueous solutions containing ozone, to clean food products. The prior art disclosures concerning this proposal are also lacking in understanding of how to achieve superior shelf life extension. For instance, U.S. Pat. No. 5,858,435 discloses a method of cleaning produce that includes the steps of rotating the produce on a conveyor while spraying it with a mixture of water and ozone, and brushing the produce with a rotating brush head so as to dislodge dirt, mold and the like from the produce by the rotating brushes, followed by another step wherein a mixture of water and ozone is applied to the produce and the produce is then treated to remove excess water from the exterior thereof, and as a final step a food grade wax is applied to the produce. This technique is completely unsuitable for many types of food products. The physical action of the brushes can dislodge or tear the food product, rendering it less visually attractive to the consumer, while in addition the brushes can not only pick up the dirt that may have been present on the food product, but also pick up shreds of the food product itself. This necessitates periodic cleaning of the brush bed, so the brush bed must be considered to be a source of fresh contamination for the food product. This patent also fails to recognize the significance to shelf life of the presence of water on the food product and within interstices of the food product. Indeed, the requirement in this patent of applying a layer of wax onto the food product confirms a failure to appreciate the significance of maximizing removal of residual water from within interstices of the food product in order to obtain a desired increase in the shelf life of the food product.

Thus, there remains a need for methods for rapidly, efficiently and effectively sanitizing food products.

### BRIEF SUMMARY OF THE INVENTION

One aspect of the present invention is a method of sanitizing a food product, comprising
(a) providing a food product having on its surface a substance that reacts with a sanitizing compound that is applied in step (c),
(b) applying an aqueous prewashing liquid onto the food product by spraying it onto all exterior surfaces of the food product from a plurality of directions while moving the food product laterally with respect to the sprays, wherein the velocity of each spray is sufficient to remove from the surfaces of the food product at least a portion of said substance,
(c) while the amount of said substance on said surfaces is below the amount present before application of step (b), applying an aqueous sanitizing liquid comprising at least one sanitizing compound onto the food product by spraying it onto all exterior surfaces of the food product from a plurality of directions while moving the food product laterally with respect to the sprays, wherein the velocity of each spray is sufficient to wet microbes adhered to the surface of the food product,
(d) maintaining contact between said sanitizing liquid and said food product for at least a time effective to maximize wetting of the surface of the food product by the sanitizing liquid, and then
(e) removing mechanically at least 75% of said liquid from said food product.

The method of this invention also prolongs the appearance of freshness of food products, especially vegetables and fruits. That is, the method of the present invention retains the fresh appearance of the food product.

As used herein, the term “food product” is meant to include any edible vegetable or animal-source product, cooked or uncooked, whether or not intact or already subdivided into portions or pieces, and includes products which are added to preparations made from food products but which are themselves not necessarily consumed, such as spices, seasonings, and herbs. Examples include, without limitation, whole animal carcasses, portions of animal carcasses, individual mouth-sized pieces cut from animal carcasses, whole vegetables and fruits, pieces of vegetables, and pieces of fruits.

As used herein, the term “sanitizing” means reducing or eliminating one or more of bacteria, microbes, molds, yeasts, and/or food spoilage enzymes, from a food product.

The “exterior surfaces” of a food product are the surfaces that can be seen by the naked eye.

By the “surfaces” of a food product is meant not only the exterior surfaces but also the surfaces in any interstices of the food product.

By “interstices” is meant irregularities, discontinuities, fissures, openings, spaces and cracks of any sort, in a food product, whether appearing in the surface of what might be considered a unitary piece such as raspberry or appearing between what might be considered severable portions of a food product such as between the leaves of a head of lettuce.

The term “mechanically” is meant to embrace techniques that remove water from the interstices of the food product without requiring thermal action such as an increase in the temperature, and without relying solely on gravity. Examples include spinning (by which is meant rotating the food product by itself or in a group with other food products so as to dislodge liquid from the food product by centrifugal force), shaking (by which is meant agitating the food product other than by spinning it, so as to dislodge liquid from the food product faster than would be the case relying solely on gravity), subjecting the food product to physical aids such as an air knife or vacuum, and the like. It will be understood that any such techniques can be carried out at any given temperature but they do not rely on increasing the temperature for their effectiveness.

### DETAILED DESCRIPTION OF THE INVENTION

This invention is particularly useful with food products having on their surface one or more substances that react with any of the one or more sanitizing compounds that are to be applied to the food product. For instance, if ozone is the sanitizing compound or one of the sanitizing compounds, then this invention is useful wherever the food product would have on its surface a substance that reacts with ozone.

Examples of such substances that react with the sanitizing compound, depending on what sanitizing compound(s) will be employed, include polysaccharides and other carbohydrates, and hydrocarbons, including but not limited to sugars, juices, blood, and wax. It should be noted that such substances might have found their way to the surface of the food product from sources other than the food product itself, and some such substances might be from the interior of the food product itself (such as blood from meats, or juices expressed from cuts or openings in a fruit or vegetable.

In this invention, an aqueous prewashing liquid is applied to all accessible surfaces of the food product by spraying it onto external surfaces of the food product. The prewashing liquid is applied at a velocity which is sufficient to remove from the surface of the food product at least a portion of the substances that would react with the sanitizing compound(s). Suitable velocities are at least 25 feet per second up to about 200-250 feet per second at the food product surface. Too slow a velocity fails to dislodge the substances sufficiently, and too high a velocity damages the surface of the food product.

For instance, the prewashing liquid can be applied in a plurality of sprays to the surface of the food product, at a velocity sufficient so that at the points at which the prewashing liquid impinges on the surface of the food product, sanitizing-reactive substances present are removed from the surface of the food product. By “sprays” is meant any flow of the liquid, whether applied through a wide angle or in a narrow stream or jet, by which the liquid impinges on the food product surface at sufficient velocity to achieve the objects described herein.

The prewashing liquid is applied while the food product is moving laterally with respect to the sprays. By “laterally” is meant that the food product is moving at an angle to the axis of the spray, rather than moving only directly toward or away from the spray.

Specific apparatus useful in this regard depends somewhat upon the geometry of the food product. Relatively round products can be moved by a roller-bar type of conveyor or a relatively conventional conveyor system under, over, or through a multi-nozzle spray manifold. Smaller products can be treated using a multi-step flighted conveyor, passing through several spray manifolds. Cut produce and similarly shaped food products cut from animal carcasses can be treated in a device presenting a rotating drum, which presents the additional feature that continuous feeding of the product can be effected through the drum, with the prewashing liquid being applied via an internal spray manifold. Such a system can also be operated on a batch basis. It will be noted that movement of the food product relative to the spray can be effected by moving the food product while the spray remains stationary, moving the spray while the food product remains stationary, or moving both.

In a preferred embodiment, the food product is carried on a conveyor (such as an endless belt) which can be slotted to permit excess liquid to pass through the conveyor, while the conveyor passes between sprays located above and below the conveyor. Preferably, in such an arrangement there are at least two sprays above the conveyor and at least two sprays below the conveyor.

The prewashing liquid can optionally but preferably contain a surfactant which in the amount used is physiologically nontoxic, in an amount effective to increase the effectiveness of the prewashing liquid in dislodging substances from the surface of the food product as described herein. Examples of suitable surfactants for this purpose include polyethylene glycol (PEG) having a molecular weight of 100 to 100,000. The amount of surfactant present in the sanitizing liquid can be in the range of 0.01 wt. % to 0.5 wt. %.

Next, a sanitizing liquid is applied to all accessible surfaces of the food product by spraying it onto all external surfaces of the food product.

The sanitizing liquid contains one or more compounds effective to inactivate food microbes present on the food product. “Agent” herein includes individual such compounds and also includes mixtures thereof. An agent that would be useful in this invention must leave no toxic residue on the food product, must be approved by governmental regulations for use on food products, and must be effective to inactivate microbes. Many such agents are known in the food treatment field. Examples include compounds of chlorine or bromine, examples of which include HOCl and ClO₂, peroxides, peracetates and peracetic acid, edible organic acids, of which the preferred examples are acetic, ascorbic, malic, lactic and citric acids, and edible inorganic acids and salts such as phosphoric acid and its sodium salts such as trisodium phosphate.

The concentration of the agent should be that which is effective to inactivate microbes. The effective concentration will vary with various agents, and with the length of time that the agent is in contact with the food product, but the effective concentration can readily be determined from published sources or by routine testing. Amounts can be from 50 or even 100 ppm up to several percent by weight. It will be recognized that the effective concentration is also a function of the contact time between the food product and the sanitizing liquid.

The sanitizing solution preferably contains ozone, at a concentration up to 15 ppm and preferably from 0.1 to 5 ppm. Ozone solutions can be formed by means conventional in the art, wherein a conventional ozone generator generates a gaseous stream of ozone, which is sparged into a stream or tank of water so as to form a solution having the desired concentration of ozone in the water.

The concentration of the sanitizing agent should be sufficient to sanitize, that is, to inactivate one or more targets such as bacteria, microbes, mold, yeast, or deleterious enzymes. The effective concentration will vary with various agents, and with the length of time that the agent is in contact with the food product, but the effective concentration can readily be determined from published sources or by routine testing. Amounts can be from 50 or even 100 ppm up to several percent by weight. It will be recognized that the effective concentration is also a function of the contact time between the food product and the sanitizing liquid.

The sanitizing liquid can optionally but preferably contain a surfactant which in the amount used is physiologically nontoxic, in an amount effective to increase the effectiveness of the sanitizing liquid in dislodging microbes from the surface of the food product when used as described herein. Examples of suitable surfactants for this purpose include polyethylene glycol (PEG) having a molecular weight of 100 to 100,000. The amount of surfactant present in the sanitizing liquid can be in the range of 0.01 wt. % to 0.5 wt. %.

One significant and unexpected advantage of the combination of ozone with the antimicrobial agent is that the combination in the sanitizing liquid provides rapid sanitizing, shelf life prolongation, and retention of the fresh appearance of the food product, with the use of less of the ozone and less of the agent than would be expected if either were used without the other.

The sanitizing liquid is applied to all external surfaces of the food product, at a velocity which is sufficient to dislodge microbes from the surface of the food product. Suitable velocities are at least 25 feet per second up to about 200-250 feet per second at the food product surface. Too slow a velocity fails to dislodge microbes sufficiently, and too high a velocity damages the surface of the food product. When the sanitizing agent comprises ozone or another compound that easily leaves solution, a low velocity is preferred so as to avoid losing too much of the compound from the solution before it has had a full opportunity to sanitize the surface of the product. Thus, a suitable velocity for applying a solution of ozone is on the order of 25 feet per second.

The sanitizing liquid can be applied in a plurality of sprays (as defined above) to the surface of the food product, at a velocity sufficient so that at the points at which the liquid impinges on the surface of the food product, microbes are dislodged from the surface of the food product.

The sanitizing liquid is applied while the food product is moving laterally (as defined above) with respect to the sprays.

Specific apparatus useful in this regard depends somewhat upon the geometry of the food product. Relatively round products can be moved by a roller-bar type of conveyor or a relatively conventional conveyor system under, over, or through a multi-nozzle spray manifold. Smaller products can be treated using a multi-step flighted conveyor, passing through several spray manifolds. Cut produce and similarly shaped food products cut from animal carcasses can be treated in a device presenting a rotating drum, which presents the additional feature that continuous feeding of the product can be effected through the drum, with the sanitizing liquid being applied via an internal spray manifold. Such a system can also be operated on a batch basis. It will be noted that movement of the food product relative to the spray can be effected by moving the food product while the spray remains stationary, moving the spray while the food product remains stationary, or moving both.

In a preferred embodiment, the food product is carried on a conveyor (such as an endless belt) which can be slotted to permit excess liquid to pass through the conveyor, while the conveyor passes between sprays located above and below the conveyor. Preferably, in such an arrangement there are at least two sprays above the conveyor and at least two sprays below the conveyor.

Following passage of the food product in contact with the sprays of the sanitizing liquid, additional contact time of the sanitizing liquid with the food product on the order of 5 seconds, preferably at least 30 seconds, should be provided. This can be provided by continuing to have the food product travel along a conveyor, by holding the food product at a holding station, or otherwise as desired by the operator. This time permits effective sanitizing in that sanitizing liquid is able to achieve maximal wetting and penetration of the surfaces of the food product while the sanitizing agent is still capable of effecting sanitizing (that is, before the agent has been consumed). That is, the solution acts at the exterior surface of the food product and is also able to penetrate into any interstices of the food product.

This interstitial penetration is another unexpected advantage of the present invention in that operation with the prewashing liquid according to this invention also prewets the product surfaces and permits the sanitizing liquid when it is applied to penetrate farther into interstices of the food product, while still able to sanitize, than has been attainable with other liquid sanitizing compositions.

This enhanced penetration is useful with sanitizing compounds like ozone, which if applied in too high a concentration can damage (burn) tender portions of the food product, because the present invention avoids the need to compensate for loss of sanitizing compound to the reactive substances by increasing the concentration of the sanitizing compound to a level that risks damaging the food product.

It is preferred that if the temperature of the product at the beginning of the prewashing step is below 40° F., then the temperature of the product should remain below 40° F. (but not below 34° F.) throughout the prewashing and sanitizing steps. It is also preferred that if the temperature of the product at the beginning of the prewashing step is above 40° F., then the temperature of the product should be reduced to less than 40° F. (but not below 34° F.) by the end of the prewashing and sanitizing steps and more preferably by the end of the prewashing step. These low temperatures help prolong the freshness and shelf life of the food product.

To achieve these objectives, the temperatures of the prewashing liquid and of the sanitizing liquid should both be below 40° F. and preferably 32° F. to 34° F., and the flow rate at which each liquid is applied to the product and the duration of each application step should be effective to to withdraw enough heat as necessary from the product to provide that the product attains a temperature in the desired range. The low temperature of the sanitizing solution helps retain more of the sanitizing agent in solution.

The prewashing and sanitizing liquids can be brought to the desired temperatures by use of one or more chillers of conventional design in which the liquid is chilled by indirect heat exchange with a coolant flowing in a separate circuit through the chiller. One chiller can be used to chill both the prewashing and sanitizing liquids (each flowing in its own circuit) or two chillers can be used, one for the prewashing liquid and one for the sanitizing liquid.

The sanitizing liquid is then removed from the food product. Removal must be effected in a manner which removes at least 75% of the sanitizing liquid present from the food product. This extent of removal is an essential aspect of the present invention, as the food product exhibits a much longer shelf life than heretofore achievable. Indeed, the ease of removal and the extent of removal of the sanitizing liquid exceeds that previously believed achievable. Removal of much higher percentages of the liquid from food products having smooth outer surfaces and no (or few) interstices, is of course achievable compared to food products with many more interstices.

Effective means for achieving this extent of removal of the sanitizing liquid from the food product include those disclosed above with respect to the definition of mechanical modes of water removal. For instance, liquid can be removed by shaking in a wire mesh basket or similar device; by spinning in a rotating drum having openings in its walls; by application to the food product of a vacuum to remove the liquid; and/or by application of a stream of air or an air knife. The liquid is thereby removed more rapidly, and more completely, than had been available in previous techniques.

This aspect of the present invention provides the additional benefit that the sanitizing liquid can be much more effectively removed from the food product (i.e. the surfaces of the food product can be dewatered) far more effectively than in previous technologies. This discovery renders the present invention all the more surprising in that, even though during the overall method of this invention the surfaces of the food product including the interstitial surfaces contain more liquid than previously attainable (due to the higher extent of penetration of the sanitizing liquid into the interstices), the invention still successfully removes such an unexpectedly high percentage of the liquid from the food product.

A preferred device for removing the sanitizing liquid from the food product is an air knife such as is described in published PCT application number WO 02/056711 A1, the content of which is hereby incorporated by reference herein.

The method of this invention deactivates deleterious enzymes from the food product surface. The method also prolongs the fresh appearance, that is, the appearance of the product when it is removed from the plant on which it grew. For instance, a green leaf of lettuce remains green with no accumulation of brown spots or brown regions on the edges of the lettuce leaf, for a period of time longer than would be expected.

In an optional next step, the food product is passed through an aqueous mist comprising a preserving agent. The aqueous mist is usually a solution or dispersion of the preserving agent. Useful preserving agents include any which are nontoxic and approved by governmental authorities for application to food products, and which are effective in prolonging the fresh appearance, the moisture content, or the freedom from spoilage, of the food product. Examples of useful preserving agents include citric acid, acetic acid, peracetic acid, hydrogen peroxide, and halogenated compounds. Other useful agents are readily identified and apparent to those familiar with the food processing field.

In another optional but preferred embodiment, the sanitizing liquid removed from the food product can be recycled and reused to prewash additional food product. Thus, the liquid is recovered as it is removed from the food product, strained/filtered to remove solid particles, sterilized (before or after removal of solid particles) by e.g. ozonation, and recycled for reapplication to additional food product. Makeup water is added to replace water which is carried out on or within the product or which is otherwise lost or spilled.

Employing a prewashing liquid that contains little or no sanitizing agent (i.e. 0 to 0.1 wt. %) permits the operator to remove materials from the food product that might react with the sanitizing compound in the sanitizing liquid. In this way, costly sanitizing compound(s) in the sanitizing liquid are not wasted by reaction with the substances that the prewashing step removes. This permits those substances to be removed at less cost than by removing them through reaction with the sanitizing compound itself, and it permits the sanitizing compound to be used for its intended purpose which is sanitizing.

Among other advantages, minimizing the amount of sanitizing compound in the prewashing liquid lets the operator avoid exposure to the sanitizing compound.

A distinct benefit of ozone sanitizing is the ozone's decomposition back into oxygen when recycling the water. Chlorine and other halogens accumulate when filtering and recycling wash water. The quick microbe kill and enzyme halting reactions of ozone washing are beneficial. That ozone is a non-selective oxidant and is easily used up oxidizing other matter in the water is advantageous and disadvantageous. Depleting ozone for the removal of color and organic compounds in waste water is a benefit. But the amount of ozone required to maintain a microbe killing residual can be very high and the generation of ozone is relatively expensive.

The system of the present invention removes biological load with auto strainers, replaceable bag filters and disposable filter elements. The removal of most of the plant tissue and field soil allows the minimum amount of ozone in filtered water to maintain a microbe killing residual. A second benefit is that when production is rushed, such as during the height of the harvesting season, fresh water can easily replace or be added to the cleaning capacity of the washer.

By using a combination of recycled and fresh water additional capacity is available for processing the food products.

Removing the field heat from products is important to slowing down product respiration, which in turn prolongs the freshness of the food product. The recycling of the cold water within the ozone washer with additional refrigeration imposes a smaller cooling load then would be the case in carrying out the complete water cooling by always starting with warm fresh water. Ozone is much more soluble in colder water, therefore it is also beneficial that less cold water is able to carry more ozone.

For this reason, it is preferred to carry out the method of the present invention with water that is 65° F. or cooler.

An additional benefit that is accrued by recycling ozonated water is control. The reservoir and water contained in the process become a buffer to rapid ozone level changes. Dissolved ozone levels will change more slowly, because the control is working on a larger volume as compared to a in line treatment system. Ozone is beneficial in that it adds dissolved oxygen and eventually reduces both BOD and COD demands. Recycling also keeps hazardous ozone levels contained within the system where they can properly be disposed of by an ozone destruct system. Open systems are avoided which could allow strong unreacted ozone solutions to spill or run off into public sewers or waterways before being treated.

1. A method of sanitizing a food product, comprising
(a) providing a food product having on its surface a substance that reacts with a sanitizing compound that is applied in step (c),
(b) applying an aqueous prewashing liquid onto the food product by spraying it onto all exterior surfaces of the food product from a plurality of directions while moving the food product laterally with respect to the sprays, wherein the velocity of each spray is sufficient to remove from the surfaces of the food product at least a portion of said substance,
(c) while the amount of said substance on said surfaces is below the amount present before application of step (b), applying an aqueous sanitizing liquid comprising at least one sanitizing compound onto the food product by spraying it onto all exterior surfaces of the food product from a plurality of directions while moving the food product laterally with respect to the sprays, wherein the velocity of each spray is sufficient to wet microbes adhered to the surface of the food product,
(d) maintaining contact between said sanitizing liquid and said food product for at least a time effective to maximize wetting of the surface of the food product by the sanitizing liquid, and then
(e) removing mechanically at least 75% of said liquid from said food product.

2. A method according to claim 1 wherein the food product is moved on a conveyor between sprays located above and below said conveyor.

3. A method according to claim 1 wherein the sanitizing liquid also comprises a surfactant in an amount which is physiologically nontoxic.

4. A method according to claim 1 wherein the prewashing liquid also comprises a surfactant in an amount which is physiologically nontoxic.

5. A method according to claim 4 wherein the sanitizing liquid also comprises a surfactant in an amount which is physiologically nontoxic.

6. A method according to claim 1 wherein the sanitizing liquid is removed mechanically from said food product by one or more of spinning, shaking, vacuum removing, or directing air onto the surface of the food product, or subjecting the food product to the action of an air knife.

7. A method according to claim 1 wherein after the step in which at least 75% of said sanitizing liquid is removed from the food product, the food product is passed through an aqueous mist which comprises a preserving agent.

8. A method according to claim 1 wherein sanitizing liquid removed from said food product is recycled and applied to additional food product in step (b).

9. A method according to claim 1 wherein the temperatures of the prewashing liquid and of the sanitizing liquid are below 40° F., and the prewashing liquid and the sanitizing liquid are each applied at a flow rate and for a length of time such that the temperature of the food product at the end of step (c) is less than 40° F.

10. A method according to claim 9 wherein the temperature of the food product at the start of step (b) is at least 40° F.

11. A method according to claim 9 wherein the temperature of the food product at the start of step (b) is below 40° F.

12. A method of sanitizing a food product, comprising
(a) providing a food product having on its surface a substance that reacts with ozone,
(b) applying an aqueous prewashing liquid onto the food product by spraying it onto all exterior surfaces of the food product from a plurality of directions while moving the food product laterally with respect to the sprays, wherein the velocity of each spray is sufficient to remove from the surfaces of the food product at least a portion of said substance,
(c) while the amount of said substance on said surfaces is below the amount present before application of step (b), applying an aqueous sanitizing liquid comprising at least ozone onto the food product by spraying it onto all exterior surfaces of the food product from a plurality of directions while moving the food product laterally with respect to the sprays, wherein the velocity of each spray is sufficient to wet microbes adhered to the surface of the food product,
(d) maintaining contact between said sanitizing liquid and said food product for at least a time effective to maximize wetting of the surface of the food product by the sanitizing liquid, and then
(e) removing mechanically at least 75% of said liquid from said food product.

13. A method according to claim 12 wherein the food product is moved on a conveyor between sprays located above and below said conveyor.

14. A method according to claim 12 wherein the sanitizing liquid also comprises a surfactant in an amount which is physiologically nontoxic.

15. A method according to claim 12 wherein the prewashing liquid also comprises a surfactant in an amount which is physiologically nontoxic.

16. A method according to claim 15 wherein the sanitizing liquid also comprises a surfactant in an amount which is physiologically nontoxic.

17. A method according to claim 12 wherein the sanitizing liquid is removed mechanically from said food product by one or more of spinning, shaking, vacuum removing, or directing air onto the surface of the food product, or subjecting the food product to the action of an air knife.

18. A method according to claim 12 wherein after the step in which at least 75% of said sanitizing liquid is removed from the food product, the food product is passed through an aqueous mist which comprises a preserving agent.

19. A method according to claim 12 wherein sanitizing liquid removed from said food product is recycled and applied to additional food product in step (b).

20. A method according to claim 12 wherein the temperatures of the prewashing liquid and of the sanitizing liquid are below 40° F, and the prewashing liquid and the sanitizing liquid are each applied at a flow rate and for a length of time such that the temperature of the food product at the end of step (c) is less than 40° F.

21. A method according to claim 20 wherein the temperature of the food product at the start of step (b) is at least 40° F.

22. A method according to claim 20 wherein the temperature of the food product at the start of step (b) is below 40° F.
